(19) United States
(12) Patent Application Publication
(10) Pub. No.: US 2016/0292934 A1
(43) Pub. Date: Oct. 6, 2016

(54) PROGRAMMABLE DEVICE

(71) Applicant: Caterpillar Inc., Peoria, IL (US)

(72) Inventors: Philip Carl Spengler, Washington, IL (US); Kristopher Eric Shaffer, Dunlap, IL (US)

(73) Assignee: Caterpillar Inc., Peoria, IL (US)

(21) Appl. No.: 15/181,603

(22) Filed: Jun. 14, 2016

(51) Int. Cl. G07C 5/00; G05B 19/042

(52) U.S. Cl. CPC G07C 5/008; G05B 19/0423

(57) ABSTRACT

A programmable device for connection to an on-board diagnostic port on a machine is provided. The programmable device includes a plurality of input interfaces. Each of the plurality of input interfaces is adapted to connect with a corresponding pin configuration of the on-board diagnostic port. The programmable device includes a position detection module configured to generate a position signal of the programmable device. Further, the programmable device includes at least two slot trays. Each of the at least two slot trays is adapted to receive a communication chip therein. The programmable device includes an expansion module adapted to provide a stackable electronic interface for the programmable device. The programmable device is a single unit configured to read data off a bus on-board the machine.

### TECHNICAL FIELD

The present disclosure relates to a programmable device. More particularly, the present disclosure relates to the programmable device for communicating data associated with a machine.

### BACKGROUND

Generally, machines include an internal bus communication network that may be used to interconnect control modules and other sensors and circuitry installed on the machine. These control modules connected to the bus may communicate with each other using a predefined network protocol. The control modules may receive input from sensors connected to bus and further utilize these inputs to monitor performance and/or control operation of other components of the machine through the bus.

Accordingly, many machines include a connection port that can be used to access modules on the bus by connecting an external device to the connection port. Known telematics solutions provide a number of external devices that may be connected in a wireless or wired manner such that the external device has access to the bus.

However, different machine types have different pin-out configurations such that various such external devices may be required to connect with the different pin-out configurations of the respective machine. Accordingly, separate external devices are required to connect to the different machine types using distinct network protocols. Additionally, known telematics solutions are complex and expensive requiring interconnection between a number of components. Hence, there is a need to provide an improved solution for accessing and communicating data associated with the machine.

U.S. Published Application number 2008/0177436 describes a communication system for use within a vehicle, between vehicles and other remotely located devices. The communication system includes a control hub for managing and analyzing multiple incoming wireless and wired data streams. The system also includes at least one sensor module wirelessly in communication with the control hub. A sensor control panel interface may be used for reviewing information from the sensor modules and a distributed mesh network may be used for supporting at least two levels therein. The communication system may be wirelessly based and may be built for rugged harsh environments such as those found in military applications and other harsh industrial applications.

### SUMMARY OF THE DISCLOSURE

In an aspect of the present disclosure, a programmable device for connection to an on-board diagnostic port on a machine is provided. The programmable device includes a plurality of input interfaces. Each of the plurality of input interfaces is adapted to connect with a corresponding pin configuration of the on-board diagnostic port. The programmable device includes a position detection module configured to generate a position signal of the programmable device. Further, the programmable device includes at least two slot trays. Each of the at least two slot trays is adapted to receive a communication chip therein. The programmable device includes an expansion module adapted to provide a stackable electronic interface for the programmable device. The programmable device is a single unit configured to read data off a bus on-board the machine.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a schematic view of the programmable device connected to an on-board diagnostic port of the machine of FIG. 1, according to one embodiment of the present disclosure; and

FIG. 3 is a schematic of a low-level implementation of a system that can be configured to perform functions of the programmable device, according to one embodiment of the present disclosure.

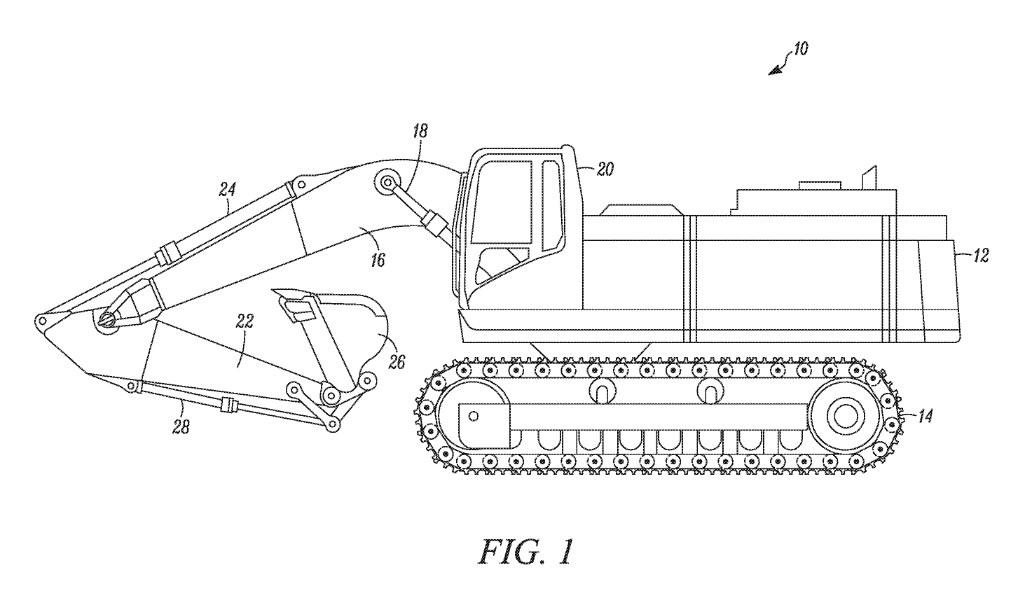

### DETAILED DESCRIPTION

Wherever possible, the same reference numbers will be used throughout the drawings to refer to the same or the like parts. FIG. 1 illustrates an exemplary machine 10 according to one embodiment of the present disclosure. The machine 10 is embodied as an excavator. It should be noted that the machine 10 may include other industrial machines such as a back hoe loader, shovel, an articulated truck, or any other machines that are known in the art. As shown in FIG. 1, the machine 10 includes a body 12 that is rotatably mounted on tracks 14.

Further, the machine 10 includes a linkage member, such as a boom 16 which is pivotally mounted on the body 12. The boom 16 extends outwards. A hydraulic cylinder 18 (or a pair of cylinders), controlled by an operator sitting in an operator cab 20 or by a machine control system, moves the boom 16 relative to the body 12 during operation. Also, a stick 22 is pivotally mounted to an outer end of the boom 16. Similarly, a hydraulic cylinder 24 is used to move the stick 22 relative to the boom 16 during excavation. Further, a bucket 26 is pivotally mounted to an outer end of the stick 22. A hydraulic cylinder 28 is connected to the bucket 26 to move the bucket 26 relative to the stick 22 during the operation.

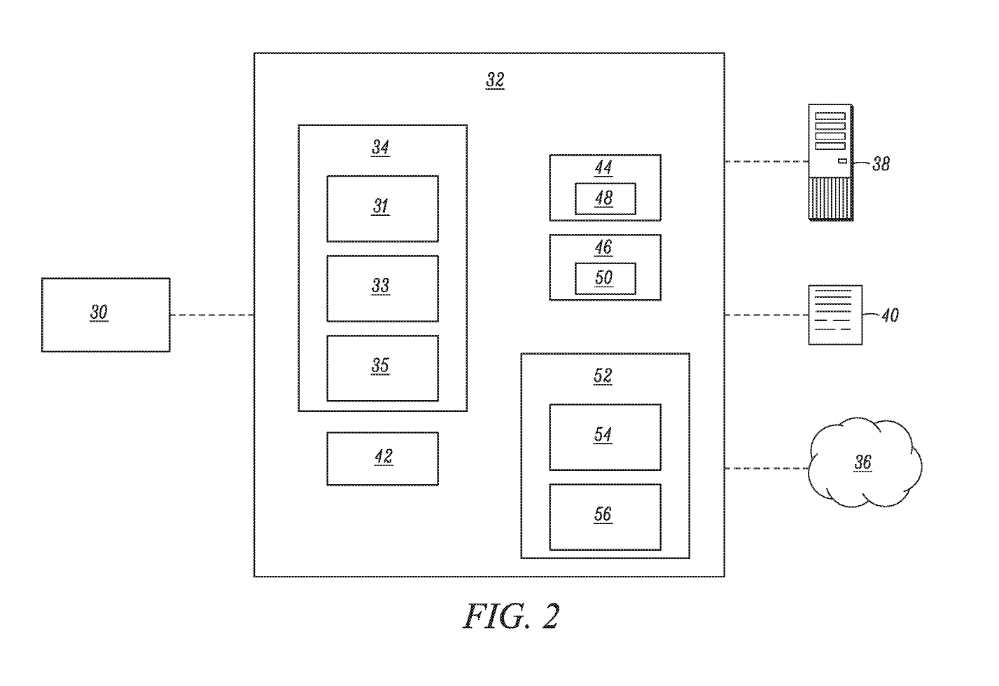

The machine 10 includes an on-board diagnostic (OBD) port 30 (see FIG. 2). The OBD port 30 is connected to a bus network, hereinafter referred to as bus, of the machine 10. A number of control modules, such as an electronic control module (ECM), and other sensors on the machine 10 are connected to the bus. The number and location of the OBD ports 30 on the machine 10 may vary. Also, a pin configuration of the OBD port 30 may vary based on a type of the machine 10. For example, the machine 10 may have a 9 pin OBD port 30 or a 16 pin OBD port 30.

The present disclosure relates to a programmable device 32 (see FIG. 2) for connecting with the OBD port 30 on the machine 10. Thus, the programmable device 32 is single unit which is connected to the bus of the machine 10 when plugged into the OBD port 30 thereof. The programmable device 32 includes a number of input interfaces 34. One of the many input interfaces 34 may be selected for installation of the programmable device 32 upon the OBD port 30. Accordingly, any one of the multiple input interfaces 34 provided on the programmable device 32 may be selected for attachment to the OBD port 30, based on the corresponding pin configuration of the OBD port 30 present on the machine 10. In the illustrated embodiment, the programmable device 32 includes three input interfaces 34, namely a 6 pin configuration 35, a 9 pin configuration 31, and a 16 pin configuration 33. Based on the input configuration of the OBD port 30 of the machine 10, the suitable input interface 34 of the programmable device 32 may be selected for attachment and insertion. Although three input interfaces 34 are described herein, the programmable device 32 may include any number of such input interfaces 34. These input interfaces 34 may be attached to a main body unit of the programmable device 32, such that a relevant interface may be selected therefrom for insertion into the OBD port 30.

The programmable device 32 may include a controller (not shown) for reading the data off the bus. Further, the programmable device 32 is capable of communicating with a personal device (not shown). In one embodiment, the personal device may be a smart phone or tablet running applications on an operating system such as iOS, Android, Windows or any available kernel. It should be noted that the examples of the personal devices included herein are exemplary and do not limit the scope of the present disclosure.

Further, the programmable device 32 is also capable of communicating directly with a cloud storage 36 and/or a remote server 38 for storage of the data read by the programmable device 32. In one embodiment, the programmable device 32 may connect through cellular or wireless networks to the Internet and through the Internet to the remote server 38 and/or cloud storage 36. Any telematics application, embedded application, or online application 40 having the capability to interpret the data transmitted by the programmable device 32 may be used to access and read the data. These telematics or online applications 32 may be installed on a computer system, the personal device, and so on.

Accordingly, the programmable device 32 may include a Wi-Fi interface (not shown) such that the programmable device 32 may transmit the data though Wi-Fi or Wi-Fi Direct. In one embodiment, the Wi-Fi interface may include a Wi-Fi antenna. The programmable device 32 may serve as a wireless access point, such that the data read from the bus of the machine 10 is transmitted to the other devices, the cloud storage 36, and/or the remote server 38 communicating with the wireless access point. The programmable device 32 may also serve as a wireless access point for interact connection and transmitting relevant machine data that is available wirelessly off the bus.

Further, the programmable device 32 includes a position detection module 42. In one embodiment, the position detection module 42 includes a global positioning system (GPS). The position detection module 42 is configured to generate a position signal indicative of a position of the programmable device 32. In one embodiment, the programmable device 32 may include a radio frequency identification (RFID) reader.

Additionally, the programmable device 32 includes two or more slot trays 44, 46 for housing communication chips 48, 50 therein. The communication chips 48, 50 may include a Subscriber identity Module (SIM) card to provide mobile telecommunication. The software or integrated circuit of the SIM card is able to be equipped with coding systems or encryption algorithms in order to protect against misuse. The multiple SIM capability provides access to the data read by the programmable device 32 to different carrier networks. Further, the accessibility of the data read and stored on the SIM card may be pre-determined and/or locked to the manufacturer.

The programmable device 32 may also include an expansion module 52. The expansion module 52 may be integrated with the programmable device 32 or snap fitted to the main body unit of programmable device 32. The expansion module 52 provides a stackable electronic interface for the programmable device 32. The expansion module 52 may include a universal serial bus (USB) connector 54, a high definition multimedia interface (HDMI) connector 56, an Ethernet port (not shown), a FireWire connector (not shown), and/or any other common electronic connection interface. In one embodiment, the USB connector 54 may be embodied as a USB female micro connector. The connectors 54, 56 of the expansion module 52 allow for the programmable device 32 to be connected to an additional personal device, storage device, or any other external device via a USB cable, HDMI, FireWire, Ethernet or other common electronic interfaces as the case may be. Additionally, the programmable device 32 may house other components such as, a printed circuit board, power circuitry, other core electronics, antennae, and data storage mediums.

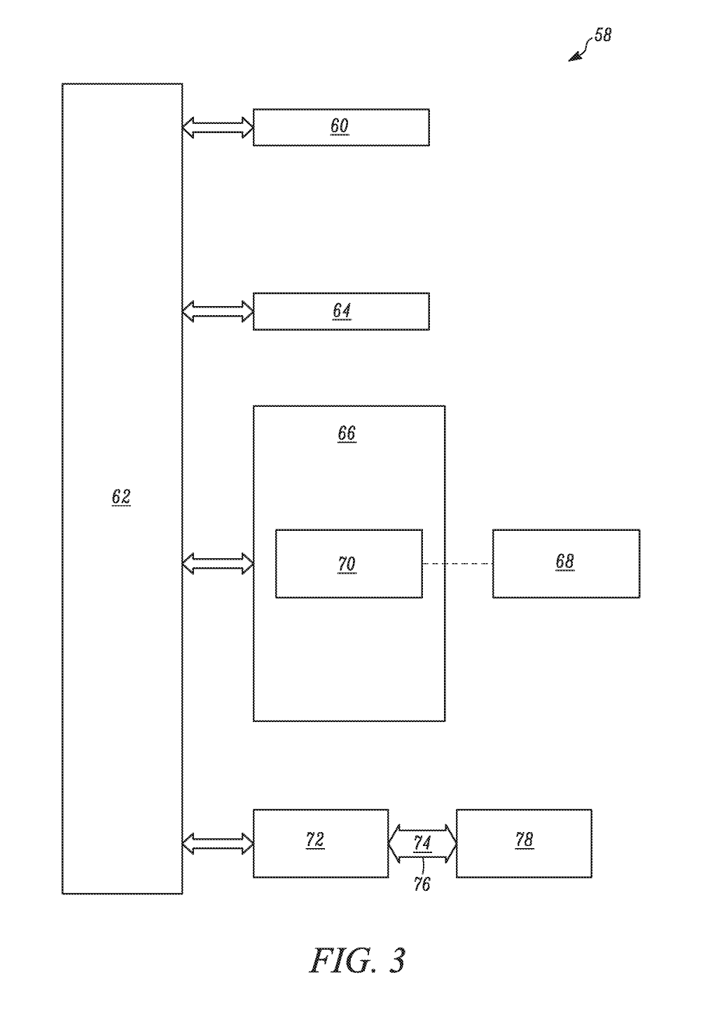

FIG. 3 is an exemplary low-level implementation of the programmable device 32 of FIG. 2. The present disclosure has been described herein in terms of functional block components, modules, and various processing steps. It should be appreciated that such functional blocks may be realized by any number of hardware and/or software components configured to perform the specified functions. For example, a computer based system, hereinafter referred as system 58 may employ various integrated circuit components, e.g., memory elements, processing elements, logic elements, look-up tables, and/or the like, which may carry out a variety of functions wider the control of one or more microprocessors or other control devices. Similarly, the software elements of the system 58 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements.

Further, it should be noted that the system 58 may employ any number of conventional techniques for data transmission, signaling, data processing, network control, and/or the like. Still further, the system 58 could be configured to detect or prevent security issues with a user-side scripting language, such as JavaScript, VBScript or the like. In an embodiment of the present disclosure, the networking architecture between components of the system 58 may be implemented by known methods.

These software elements may be loaded onto a general purpose device, special purpose device, or other programmable data processing apparatus to produce a machine, such that the instructions that execute on the computer or other programmable data processing apparatus create means for implementing the functions disclosed herein. These computer program instructions may also be stored in a computer-readable memory that can direct a computer or other programmable data processing apparatus to function in a particular manner, such that the instructions stored in the computer-readable memory produce instructions which implement the functions disclosed herein. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions disclosed herein.

The system 58 includes at least one processor, such as a processor 60. The processor 60 may be connected to a communication infrastructure 62, for example, a communications bus, a cross-over bar, a network, and the like. Various software embodiments are described in terms of this exemplary system 58. Upon perusal of the present description, it will become apparent to a person skilled in the relevant art(s) how to implement the present disclosure using other computer systems and/or architectures.

The system 58 further includes a main memory 64, such as random access memory (RAM), and may also include an expandable secondary memory 66. In accordance with various embodiments of the present disclosure, the secondary memory 66 may include other similar devices for allowing computer programs or other instructions to be loaded into the system 58. Such devices may include, for example, a removable memory chip 68, and an interface 70. Examples of such may include an erasable programmable read only memory (EPROM), or programmable read only memory (PROM)) and associated socket, and other removable storage units and interfaces, which allow software and data to be transferred from the removable memory chip 68 to system 58.

The system 58 may further include a communication interface 72. The communication interface 72 allows software and data to be transferred between the system 58 and external devices 78. Examples of the communication interface 72 include, a network interface (such as an Ethernet card), a communications port, an Ethernet or USB port, and the like. Software and data transferred via the communication interface 72 may be in the form of a plurality of signals, hereinafter referred to as signals 74, which may be electronic, electromagnetic, optical or other signals capable of being received by the communication interface 72. The signals 74 may be provided to the communication interface 72 via a communication path (e.g., channel) 76. The communication path 76 carries the signals 74 and may be implemented using wire or cable, fiber optics, a telephone line, a cellular link, a radio frequency (RF) link and other communication channels.

### INDUSTRIAL APPLICABILITY

The programmable device 32 provides an integrated and cost effective solution for reading data off the bus on the machine 10 and transmitting the data to the remote server 38, online applications 40, and/or cloud storage 36. The programmable device 32 is a platform agnostic device that may be plugged into and operated in connection with a variety of the machines 10. Due to the multiple selectable and configurable input interfaces 34 of the programmable device 32, the same programmable device 32 can be used on the machines 10 having different pin configurations. The programmable device 32 allows for modular expansion of the bus of the machine 10 by reading, logging and/or transmitting the data of the machine 10 to the remote server 38, online applications 40, and/or cloud storage 36.

The programmable device 32 may be easily programmed to work on the different machines 10 as a plug and play device providing real-time diagnostic information obtained through the bus of the machine 10. The programmable device 32 may be easily used in connection with any bus within the DC voltage range. Any bus outside the DC voltage range may be read utilizing a voltage stepper provided within the programmable device 32.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A programmable device for connection to an on-board diagnostic port on a machine, the programmable device comprising:
a plurality of input interfaces, each of the plurality of input interfaces adapted to connect with a corresponding pin configuration of the on-board diagnostic port;
a position detection module configured to generate a position signal of the programmable device;
at least two slot trays wherein each of the at least two slot trays is adapted to receive a communication chip therein; and
an expansion module adapted to provide a stackable electronic interface for the programmable device,
wherein the programmable device is a single unit configured to read data off a bus on-board the machine.
